(19) United States
(12) Patent Application Publication
(10) Pub. No.: US 2012/0259613 A1
(43) Pub. Date: Oct. 11, 2012

(54) Advance Phase Modeling, Simulation and Evaluation Method of a Computation Platform

(75) Inventor: Michaël Lafaye, Meudon La Foret Cedex (FR)

(73) Assignee: Thales, Neuilly Sur Seine (FR)

(21) Appl. No.: 13/439,596

(22) Filed: Apr. 4, 2012

(30) Foreign Application Priority Data
Apr. 5, 2011 (FR) FR 11 01017

(51) Int. Cl. G06F 9/44

(52) U.S. Cl. 703/21

(57) ABSTRACT

The method comprises the following steps:
establishing a low-level computation platform model (10) from sets of sizing parameters (4) representative of the material and/or software resources necessary to carry out requests generated during the implementation of the or each application (2), the low-level model (10) comprising at least one computation node (60) modeling at least one application (2), material components, one or more operating systems, and services;
defining at least one stimulation scenario (6), corresponding to a sequence of generated requests;
stimulating the low-level model (10) of the computation platform using the or each scenario and using an event-driven simulation kernel of the stimulation scenario determined as a function of process planning,
   and,
noting the traces of the operation of the low-level model (10) to evaluate the performance thereof.

The present invention relates to the field of evaluating the performance of computation platforms, whether onboard or not, intended to implement at least one computer application.

Computation platforms (whether onboard or not) are electronic and computer systems dedicated to one or more tasks. They are present in a large number of fields such as automobiles, railroads, and avionics. A computation platform (whether onboard or not) is made up of one, and generally several, computers connected by an interconnect medium. Each computer can have one or more operating systems and offer platform services to process various functions.

For example, avionics platforms are among the most restrictive because of the different safety rules and standards that must be followed. Recent avionics platforms are designed according to the IMA (Integrated Modular Avionics) principle: a computer can take on several independent applications that can have different criticality levels (criticality levels defined by standard DO 178-B). The IMA principle thus allows a significant reduction in the total number of computers onboard an airplane, which causes a decrease in the occupied space, weight, consumption, and development costs for those platforms.

The IMA principle has also been made possible owing to the introduction of a deterministic network enabling communication between the various computers of the platform, in particular a network meeting standard ARINC664. Furthermore, standard ARINC653 defines certain safety rules for the real-time onboard OS running on said computers and makes it possible to offer spatial partitioning (each application of the computer has its own memory space as well as its reserved I/O access) and time partitioning (each application of the computer has an allotted runtime window), which on the one hand guarantees access for an application to all of the authorized resources during its runtime, and also guarantees that an error in the application will not contaminate the other applications on the same computer.

In the process of developing these platforms, designers have experienced difficulties in designing and validating a platform architecture in phase advance, since the application and the material architecture are only partially known.

One aim of the invention is to propose a method for modeling and simulating a computation platform making it possible to evaluate the performance of a platform in phase advance, with sufficient precision to make it possible to determine the best compromise in the material architecture size/applications of the computation platform (whether onboard or not).

To that end, the invention proposes a computer-assisted modeling, simulation, and evaluation method in phase advance of the computation platform as a function of at least one application, the computation platform comprising material components, one or more operating systems, the or each application generating, when it is run, requests to be carried out by the material components, the method comprising the following steps:
establishing a low-level computation platform model from sets of sizing parameters representative of the material and/or software resources necessary to carry out requests generated during the implementation of the or each application, the low-level model comprising at least one computation node modeling at least one application, material components, one or more operating systems, and services for implementing the or each application of the computation node;
defining at least one stimulation scenario, each scenario corresponding to a sequence of requests generated when the or each application is run;
stimulating the low-level model of the computation platform using the or each stimulation scenario and using an event-driven simulation kernel of the stimulation scenario determined as a function of process planning, and
noting the traces of the operation of the low-level model to evaluate the performance thereof during implementation of the or each application.
According to other embodiments, the modeling and simulation method comprises one or more of the following features, considered alone or according to all technically possible combinations:
a low-level model is established comprising several computation nodes connected by an interconnect medium;
the application(s) is (are) modeled within each computation node by application modules;
the services of a service layer within each computation node are modeled by service modules;
an interface layer is modeled between the applications and the services within each computation node by an interface module modeling an API;
the material components are modeled within each computation node by behavioral material component modules, each behavioral material component module comprising a behavioral software automaton.
access to the material services is modeled within each computation node by material service modules, each material service module being capable of receiving, processing, and transmitting the requests sent to the behavioral material component module;
each module modeling an application, material component, or service is encapsulated in a software container configured to serve as communication interface with at least one communication bus making it possible to send frames and/or stimuli through the model;
each container operates according to the subscription principle, and relays, from the communication buses to the modeling module to which it is attached, only the frames and/or stimuli to which it subscribes;
the steps are applied iteratively to determine the low-level platform model;
the establishment of a platform model comprises the following steps:
producing a high-level platform model from sizing parameter sets, the high-level model comprising descriptive material modules defined by the sets of properties; and
establishing the refined low-level platform model from the high-level model by replacing the descriptive material modules with refined behavioral material modules comprising behavioral automatons and by developing service modules modeling operating system services required by the applications;
the high-level model is established in an architectural definition language, such as AADL or XML.
the low-level model is established in a material component behavioral modeling language comprising a simulation core, in particular SystemC.

The invention and its advantages will be better understood upon reading the following description, provided solely as an example, and done in reference to the appended drawings, in which:

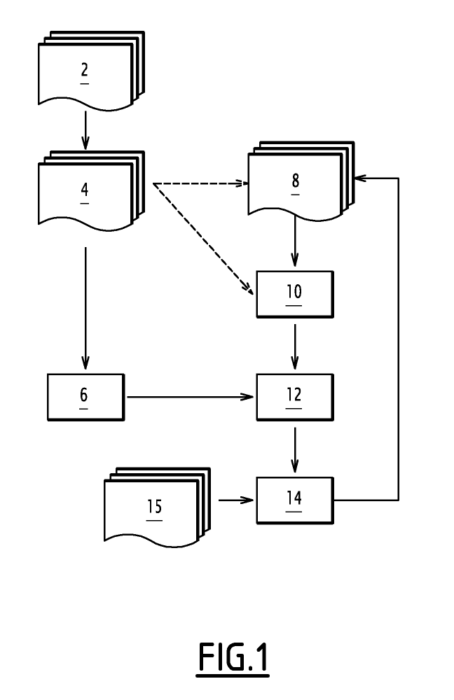

FIG. 1 is a diagram diagrammatically illustrating a computer-assisted modeling, simulation, and evaluation method of a computation platform according to the invention;

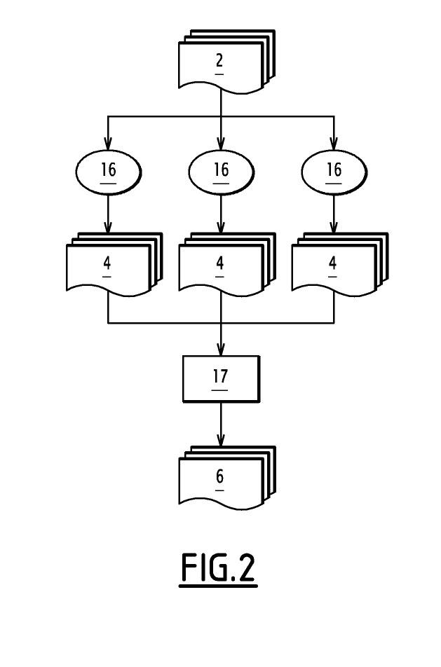

FIG. 2 is a diagram diagrammatically illustrating a step for generating a stimulation scenario of a computation platform model according to the method;

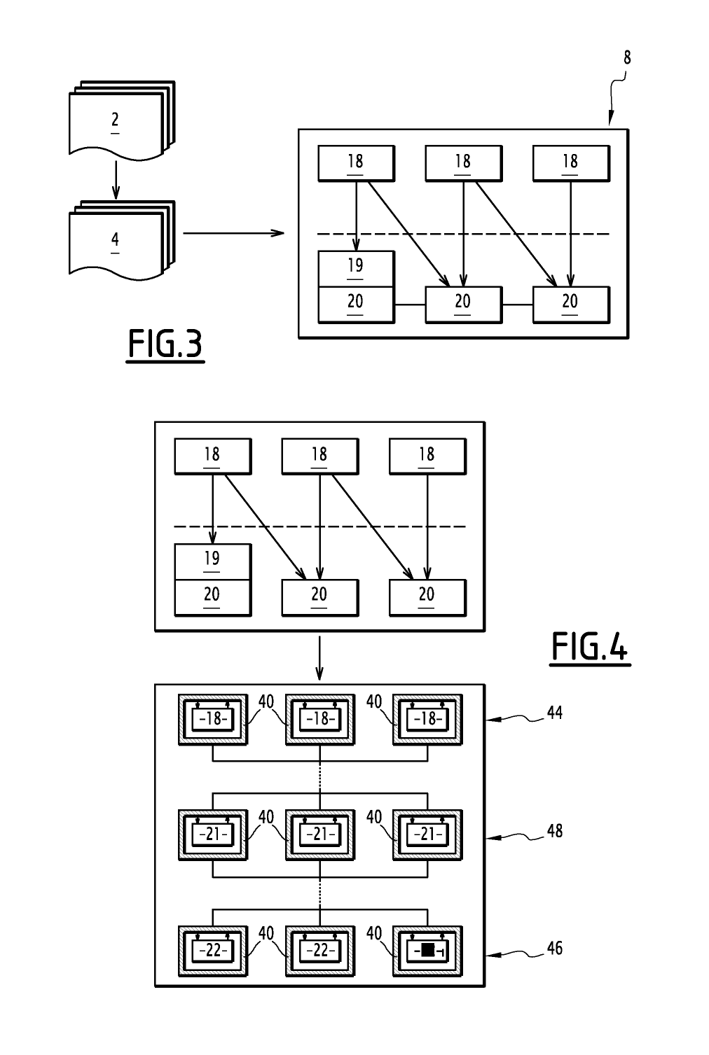

FIG. 3 is a diagram diagrammatically illustrating a high-level modeling step of a computation platform according to the method;

FIG. 4 is a diagram diagrammatically illustrating a low-level modeling step of the computation platform according to the method;

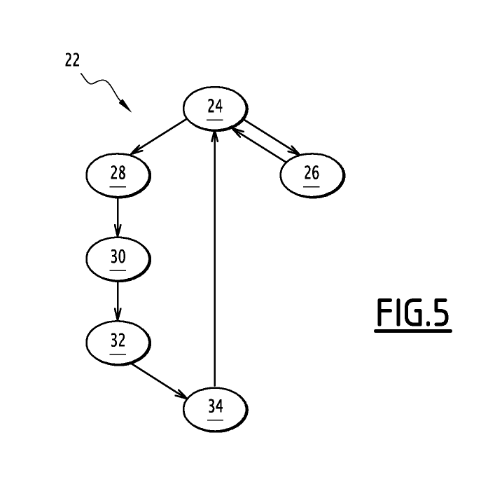

FIG. 5 is a diagram diagrammatically illustrating a behavioral module of a material component, in this case RAM memory;

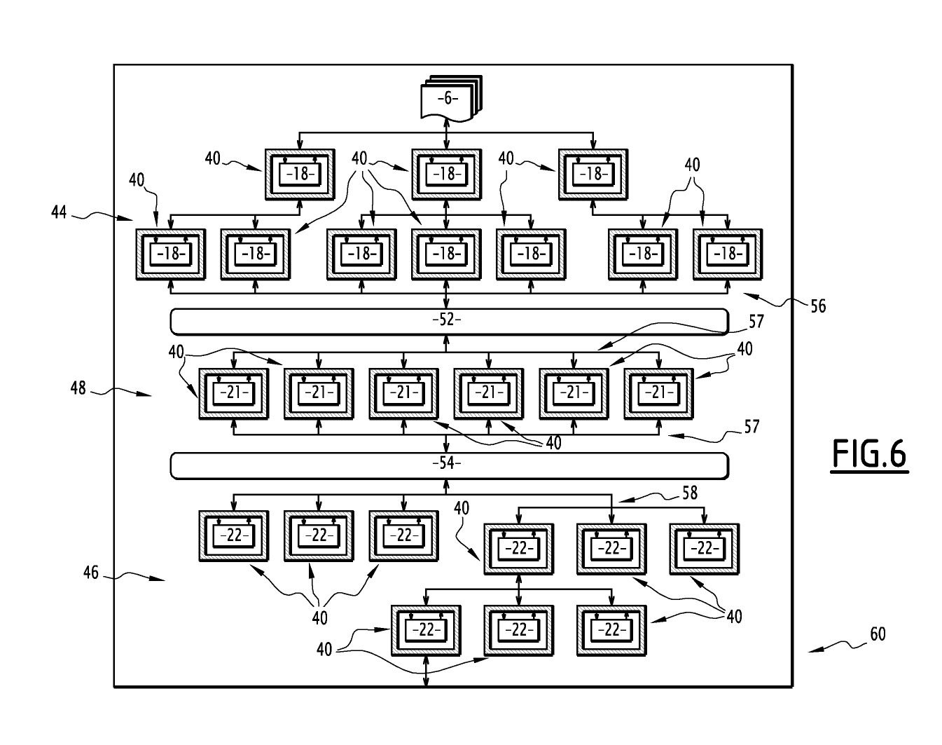

FIG. 6 is a diagram diagrammatically illustrating the computation platform using software containers for an application layer, a service layer, and a material layer;

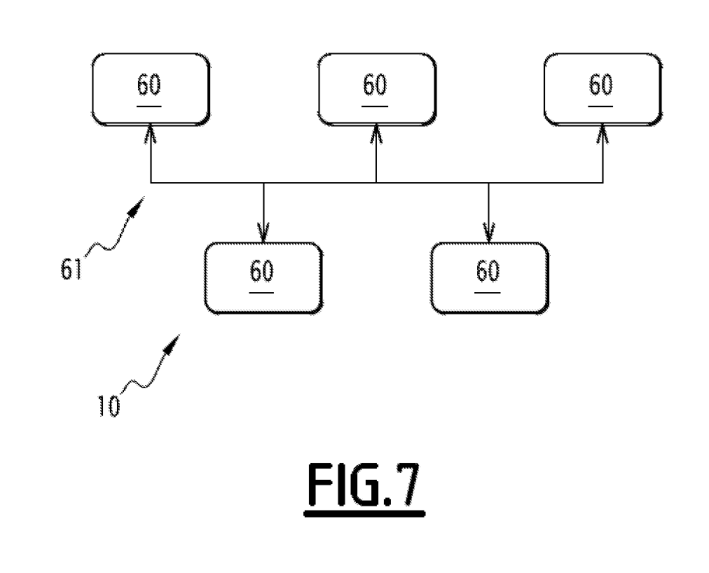

FIG. 7 is a diagram diagrammatically illustrating a computation platform, made up of computation nodes connected by a communication medium.

FIG. 1 diagrammatically illustrates a computer-assisted method for modeling, simulating, and evaluating the performance of a computation platform for the implementation of computer applications 2 according to the invention.

The method comprises:
a step for characterizing the applications 2 in which one determines, for each application 2 intended to be implemented on the computation platform (onboard or not), a set of sizing parameters 4;
a step for generating one or more stimulation scenarios 6 from sets of sizing parameters 4 corresponding to a chain of requests that may be emitted by the applications 2;
a so-called “high-level” modeling step in which one determines a high-level platform model 8 partially owing to the set of sizing parameters 4 previously extracted;
a so-called “low-level” modeling step in which one determines a refined or low-level platform model 10 from the high-level platform model 8;
a simulation step, in which one stimulates the low-level model 10 according to the stimulation scenarios previously generated; and

an evaluation step 14, in which one evaluates the performance 12 of the refined model 10 to implement the applications 2 so as to look at whether said applications respect the requirements that the platform must meet.

Each application 2 implements several processes, each process corresponding to a set of instructions, and each process generating, when it is run, requests intended to be carried out by the material components of the onboard platform under the control of at least one OS (operating system), for which several planning policies can be considered.

The material components are of the microprocessor, cache memory, L1 memory, L2 memory, RAM memory (SRAM, DRAM, etc.), ROM memory, RAM static memory, programmable component (FPGA, CPLD, EPLD, other type), input/output interface, or communication type, and any other component that can be instantiated on a computation platform.

The requests are requests such as a computation to be done by a processor or by a programmable component (FPGA, CPLD, EPLD, or other type), write or read requests in a memory or registers, requests to access an input/output interface, requests to access a bus, and any other request to access the components of the computation.

The characteristics of each set of sizing parameters 4 correspond to the material resources necessary to process the requests that may be generated by the corresponding application 2. A set of sizing parameters 4 varies from one application 2 to another, and can even change for a same application 2 after evaluating the parameters first selected. It may for example comprise, for each process of an application 2, the sequence code level (requests that must be performed sequentially), the parallel code level (requests that can be performed in parallel), the memory access numbers for each type of memory (cache, L1, L2, ROM, RAM, etc.), the memory space necessary for each type of memory, the access level to the processor, the floating data level, the whole data level, the input/output I/O level, or the different accesses to the services offered by the operating system OS, etc.

At an advanced stage where the code of an application is known, the step for characterizing the application 2 is for example carried out using a parser implemented by computer and capable of analyzing the code of the application 2 so as to automatically determine a set of sizing parameters 4 of the application 2 called “stimuli.”

At an earlier stage, it is generally possible to determine a set of sizing parameters 4 in advance that is precise enough for a particular application that is not yet coded.

As illustrated in FIG. 2, in the step for generating a scenario, for each process 16 of each application 2, a set of sizing parameters 4 is determined and a request frame is generated, i.e. a series of requests, taking into account the planning policy of the processes. The frame is generated using a frame generator 17.

As illustrated in FIG. 3, in the high-level modeling step, an onboard high-level platform model 8 is generated taking into account the sets of sizing parameters 4 determined for each application 2.

The high-level model 8 comprises application modules 18 and descriptive material component modules 20.

Each application module 18 models an application 2 intended to be implemented on the platform and comprises at least one set of sizing parameters 4.

Each descriptive material component module 20 models a material component of the platform and has a set of properties making it possible to simulate a response to the requests generated by the applications 2. The set of properties of the material component is determined so as to correspond to the sets of sizing parameters 4 of the applications 2.

The set of properties of each descriptive material component module 20 comprises characteristic properties of each component, such as, for example, frequency, number of processing units of the whole data, number of processing units of the floating data for a processor, capacity, latency during write or read access for a memory, conversion latency of the signal for an input/output interface, and all other primary characteristics

The high-level model 8 comprises auxiliary modules 19. Each auxiliary module 19 is associated with a descriptive material component module 20 and models one or more services offered by the operating system of the platform to the or each application 2, which may be referred to as an application programming interface or API, by means of the associated descriptive material component module 20. The descriptive material component module 20 for example models a microprocessor.

The high-level model 8 is developed either by an existing tool that generates a model in the form of an XML or other file, or in a system architecture definition language, preferably intended for onboard systems, for example AADL (Architecture Analysis and Design Language). The definition language makes it possible to define the application modules and material modules, each module being able to have characteristics or properties and comprise sub-modules. An application can thus be modeled by a module comprising, for each process, a sub-module, which in turn comprises a set of sizing parameters.

In the step for generating a low-level model, a refined low-level model 10 of the platform is generated from the high-level model 8.

As illustrated in FIG. 4, in this step, the descriptive material component modules 20 are replaced by behavioral material component modules 22, and the auxiliary module(s) 19 are in particular replaced by a set of service modules 21.

Each behavioral material component module 22 comprises a behavioral automaton that can be parameterized via certain primary properties, and makes it possible to simulate the behavior of the corresponding material component.

Each service module 21 models a service offered by the operating system OS.

To determine the behavioral material component modules 22, a computer-assisted syntax analysis of the high-level model 8 is done using a parser capable of determining, from a high-level model 8, the various corresponding material components and their properties. Then, a configurable behavioral material component module corresponding to each material component is recovered from a component library, and the behavioral material component module is parameterized as a function of the properties of the material component.

The properties used to parameterize the behavioral material component module can be of one or several types depending on the parameters one wishes to validate and optimize owing to the modeling and simulation of the computation platform. The parameters are, for example, time, consumption, reliability, heat dissipation parameters, making it possible to characterize each component according to a multi-criteria or multi-perspective analysis. In this way, the behavioral automaton is capable, in response to a request, of simulating the different aforementioned sizes.

FIG. 5 is a diagram illustrating one example of a behavioral material component module 22 simulating a RAM memory (SRAM, DRAM, other) according to time criteria. Thus, the behavioral material component module 22 simulates a wait state 24, a refresh function 26, a start read function 28, a read function 30, an end read function 32, and a return function 34. Each step is characterized by a duration necessary to carry out the associated function. The behavioral material component module 22 makes it possible to determine the response time according to the requests carried out.

Returning to FIG. 4, the application modules 18 belong to an application layer 44 modeling an application part, the behavioral material component modules 22 belong to a material layer 46 modeling a material part, and the service modules 21 belong to a service layer 48 modeling a middleware part.

The application modules 18, service modules 21, and behavioral material component modules 22 are each encapsulated in a software interfacing container 40.

Each container 40 has properties making it possible to:
interface each module of the same layer (application layer 44, service layer 48, material layer 46),
connect the modules of the same layer to a same communication bus.

The containers 40 come from a generic module that can be parameterized as a function of the application, service, or behavioral material component module with which it is associated and which allows transparent management of the connections.

The containers 40 of a same layer are connected by a single bus so as to receive all communications. Each container 40 is parameterized so as to transmit, to the associated module, only the frames and/or stimuli intended for that module (e.g. the frames and/or stimuli modeling the requests intended to be processed by a behavioral material component module 22).

Using containers 40 makes it possible to simplify modeling of the platform by doing away with the traditional system consisting of connecting the different modules to each other, and in particular the material component modules. The container-based 40 low-level model 10 allows a reliable enough simulation while being easy to develop. The proposed invention offers an iterative method that makes it possible to refine the low-level model 10 as needed simply by adding, modifying and/or removing a behavioral material component module 22.

As shown in FIG. 6, more completely illustrating a low-level model 10, a low-model model 10 is generated in which the service layer 48 also comprises an interface module 52 arranged between the service modules 21 and the application layer 44 and a material service module 54 arranged between the service modules 21 and material layer 46.

The interface module 52 models an application programming interface, or API, which centralizes the calls from applications to the services of the service layer 48, verifies that the call corresponds to an authorized operation, and relays the call to the associated service module 21.

The material service module 54 models a material component performing a service shared by the different material components modeled by the behavioral modules 22. The material service module 54 for example models a control unit in the form of a software automaton integrated into the processor and that generates control and command signals to steer the control operations performed before accessing the material resources, such as verification of the validity of a memory access request by an application.

The containers 40 of the application layer 44 are connected to the interface module 52 by a single application bus 56. The containers 40 of the service layer 48 are each connected to an interface module 52 and the material service module 54 by a single service bus 57. The material service module 54 is connected to the containers 40 of the material layer 44 by a single material bus 58.

A computation platform can comprise a plurality of computation nodes connected to one another by a communication medium. Thus, as illustrated in FIG. 7, a low-level model 10 modeling a corresponding platform can comprise several computation nodes 60 connected to each other by a communication medium 61, each computation node 60 being modeled by a model as illustrated in FIG. 6.

The low-level model 10 is developed in a material definition language allowing a behavioral definition of the material components. A simulation core is also used making it possible to simulate the model so as to implement stimulation scenarios dynamically simulating a series of events and to monitor the signals or “traces” representative the operation of the platform in its entirety or each component of the platform. This is done so as to determine whether the platform is compatible with the determined criteria or requirements. The low-level model 10 is for example developed in the SystemC language, comprising an event-driven simulation core.

The criteria or requirements 15 are for example time constraints to be respected for each process, memory usage constraints, heat dissipation constraints, or reliability constraints.

In the stimulation step, the low-level computer platform model 10 is stimulated with computer assistance using an event-driven simulation kernel, based on one or more stimulation scenarios previously developed. The SystemC language comprises an event-driven simulation core.

Based on the stimulation scenario, the application modules 18 emit requests that are sent to the interface module 52, which sends them to the different services of the service layer 48. Each service translates these high-level requests into elementary requests that can be run by the behavioral material component modules 22. Each elementary request resulting from these high-level requests is sent to all of the containers 40 encapsulating the behavioral material component modules 22, which only accept the elementary requests concerning them. Each behavioral material component module 22 responds to the elementary request concerning it. If applicable, the emission of a new elementary request by the material service module 54 to the material component behavioral modules 22 may require waiting for a response to a previous elementary request according to the sequence to be followed. The responses to the requests are escalated to the material service module 54 by means of the material bus 58 and the containers 40 of the material layer 46.

In the performance analysis step, representative traces of the operation and performance of the platform are noted. These traces can then be analyzed to determine whether the platform is operating appropriately to implement the concerned applications. If not, it is possible to resume the method iteratively from the high-level modeling and stimulation steps to modify the platform model iteratively so as to improve the operation thereof during implementation of the applications. The compliance of the platform is done by comparison, by means of an analysis module, of the responses of the platform to the stimuli (i.e. the performance of the platform) and the requirements (i.e. the expected performance of the platform).

A system for implementing the method according to the invention comprises a computer having a processor and at least one computer program that can be run so as to implement the method. The system in particular comprises a high-level system architecture definition program, preferably intended for onboard systems, of the AADL or MARTE type, a behavioral material definition program making it possible to define the material components using behavioral automatons, comprising a library of configurable behavioral models, and an event-driven simulation core, of the event-driven simulation core type using the SystemC material definition language.

The invention also relates to a computer program product recorded on a data medium, which can be run on a computer and comprising a system architecture definition program, for example intended for onboard systems, of the AADL type, and a behavioral material definition program making it possible to define the material components using behavioral automatons, comprising a library of configurable behavioral models and an event-driven simulation core, of the SystemC type.

The method for simulating a computation platform (onboard or not) according to the invention makes it possible to perform modeling at an early stage of the design of the computer platform with a sufficient degree of precision to validate the computation platform (onboard or not) architecture, without, however, necessarily having software applications intended to be implemented on the platform and without freezing the platform, and therefore leaving greater freedom to design software applications.

In particular, the modeling of the material part is based on a low-level model integrating configurable behavioral material modules modeling the material components, in particular developed in a low-level material definition language such as SystemC, allowing a more subtle simulation of the high-level model, in which the modules simulating the material components are defined only by a set of properties, for example in the AADL language. Furthermore, these behavioral models can be parameterized according to several different perspectives, such as time, reliability, operating security, or consumption.

Furthermore, the low-level model uses software containers and a representation integrating a central service layer comprising a set of service modules serving as interface between the application modules and the material component modules and communicating with the material layer by means of a single material bus. The software containers offer great flexibility and configurability in the connection/disconnection of the different modules. Each module modeling an application, a service, or a material component being connected to its container, the number of connections is reduced to two, irrespective of the module.

Owing to a subscription mechanism, each container associated with a material component module receives all of the requests, and only relays to the material component module those requests for which it is “subscribed” (notion of contract between the material component module and the container). It is therefore no longer necessary to precisely know the number of ports of each component or the connections between the components simulated by the material component modules. The container is also a configurable generic element that extracts the connection interface part from the associated module, which makes it possible, during the development of the new module, to concentrate on the purely behavioral part.

Furthermore, the method according to the invention is based on a simulation kernel. The performance analyses done are thus for dynamic performance, more precise than static performance.

The iteration of the process offers the possibility of modifying or refining the generated platform (assembly of elementary components: material, operating system, platform services) so that it is best suited to the application called upon to be run thereon.

These advantages make it possible to obtain an iterative phase advance modeling and validation method, which is flexible and configurable, while having good precision in performance analyses relative to the actual platform.

The invention applies to the simulation of computation platforms, whether in the avionics, railways, automobiles, naval applications, land applications, or others.

What is claimed is:

1. A computer-assisted modeling, simulation, and evaluation method in phase advance of the computation platform as a function of at least one application, the computation platform comprising material components, one or more operating systems, the or each application generating, when it is run, requests to be carried out by the material components, the method comprising the following steps:
establishing a low-level computation platform model from sets of sizing parameters representative of the material and/or software resources necessary to carry out requests generated during the implementation of the or each application, the low-level model comprising at least one computation node modeling at least one application, material components, one or more operating systems, and services for implementing the or each application of the computation node;
defining at least one stimulation scenario, each scenario corresponding to a sequence of requests generated when the or each application is run;
stimulating the low-level model of the computation platform using the or each stimulation scenario and using an event-driven simulation kernel of the stimulation scenario determined as a function of process planning,
and,
noting the traces of the operation of the low-level model to evaluate the performance thereof during implementation of the or each application.

2. The method according to claim 1, wherein a low-level model is established comprising several computation nodes connected by an interconnect medium.

3. The method according to claim 1, wherein the application(s) s (are) modeled within each computation node by application modules.

4. The method according to claim 1, wherein the services of a service layer within each computation node are modeled by service modules.

5. The method according to claim 4, wherein an interface layer is modeled between the applications and the services within each computation node by an interface module modeling an API.

6. The method according to claim 1, wherein the material components are modeled within each computation node by behavioral material component modules, each behavioral material component module comprising a behavioral software automaton.

7. The method according to claim 6, wherein access to the material services is modeled within each computation node by material service modules, each material service module being capable of receiving, processing, and transmitting the requests sent to the behavioral material component module.

8. The method according to claim 1, wherein each module modeling an application, material component, or service is encapsulated in a software container configured to serve as communication interface with at least one communication bus making it possible to send frames and/or stimuli through the model.

9. The method according to claim 8, wherein each container operates according to the subscription principle, and relays, from the communication buses to the modeling module to which it is attached, only the frames and/or stimuli to which it subscribes.

10. The method according to claim 1, wherein the steps are applied iteratively to determine the low-level platform model.

11. The method according to claim 1, wherein the establishment of a platform model comprises the following steps:
producing a high-level platform model from sizing parameter sets, the high-level model comprising descriptive material modules defined by the sets of properties; and
establishing the refined low-level platform model from the high-level model by replacing the descriptive material modules with refined behavioral material modules comprising behavioral automatons and by developing service modules modeling operating system services required by the applications.

12. The method according to claim 11, wherein the high-level model is established in an architectural definition language, such as AADL or XML.

13. The method according to claim 1, wherein the low-level model is established in a material component behavioral modeling language comprising a simulation kernel, in particular SystemC.
